(19) United States
(12) Patent Application Publication
(10) Pub. No.: US 2023/0356504 A1
(43) Pub. Date: Nov. 9, 2023

(54) GLASS-GLASS LAMINATES AND METHODS OF MANUFACTURING AND CUTTING THE SAME

(71) Applicant: CORNING INCORPORATED, CORNING, NY (US)

(72) Inventors: Jae-seon Hong, Uiwang-si (KR); Hyung Soo Moon, Seoul (KR); Seung-yong Park, Asan-si (KR)

(21) Appl. No.: 18/027,269

(22) PCT Filed: Sep. 15, 2021
(86) PCT No.: PCT/US2021/050366

§ 371 Date: Mar. 20, 2023

(30) Foreign Application Priority Data
Sep. 21, 2020 (KR) 10-2020-0121787

(51) Int. Cl. B32B 17/10; C03C 27/10

(52) U.S. Cl. CPC B32B 17/10036; C03C 27/10; B32B 17/10045; B32B 17/10266; B32B 17/10706; B32B 17/10908; C03C 2217/72; B32B 2451/00

(57) ABSTRACT

Provided is a glass-glass laminate. The glass-glass laminate includes a lower glass layer, an adhesive layer on the lower glass layer, an upper glass layer on the adhesive layer, and a decoration layer between the lower glass layer and the adhesive layer or between the upper glass layer and the adhesive layer, in which the adhesive layer includes a room-temperature adhesive material.

### CROSS-REFERENCE TO RELATED APPLICATION

This application is based on and claims priority under 35 U.S.C. § 119 to Korean Patent Application No. 10-2020-0121787, filed on Sep. 21, 2020, in the Korean Intellectual Property Office, the disclosure of which is incorporated by reference herein in its entirety.

### BACKGROUND

### 1. Field

The disclosure relates to glass-glass laminates, a method of manufacturing the same, and a method of cutting the same. In detail, the disclosure relates to a glass-glass laminate having a decoration layer, a method of manufacturing the same, and a method of cutting the same.

### 2. Description of Related Art

A glass laminate may include a substrate, a glass layer, and an adhesive layer for adhering the glass layer to the substrate. The glass-glass laminate is a glass laminate including a second glass layer as a substrate. In other words, the glass-glass laminate may include two glass layers attached to each other by the adhesive layer. In general, a poly vinyl butyral (PVB) film may be used as an adhesive layer for attaching the two glass layers. However, when a PVB film is used as the adhesive layer, a high-temperature process for thermally curing the PVB film is necessary. Accordingly, it is difficult to insert a decoration layer that is vulnerable to heat between the glass layers, and internal stress may be formed in the glass layers due to heat. Furthermore, after the PVB film is thermally cured, it may be difficult to cut and process the glass-glass laminate.

### SUMMARY

Provided is a glass-glass laminate that is easy to cut and process and does not require a high-temperature process for manufacture.

Additional aspects will be set forth in part in the description which follows and, in part, will be apparent from the description, or may be learned by practice of the presented embodiments of the disclosure.

According to an embodiment, a glass-glass laminate includes a lower glass layer, an adhesive layer on the lower glass layer, an upper glass layer on the adhesive layer, and a decoration layer between the lower glass layer and the adhesive layer or between the upper glass layer and the adhesive layer, in which the adhesive layer includes a room-temperature adhesive material.

In some embodiments, the thickness of the upper glass layer may range from about 0.1 mm to about 1.5 mm.

In some embodiments, the absolute value of warpage of the upper glass layer may range from about 0 μm to about 500 μm.

In some embodiments, the thickness of the lower glass layer may range from about 0.1 mm to about 17 mm.

In some embodiments, the thickness of the lower glass layer may range from about 0.4 mm to about 12 mm.

In some embodiments, the decoration layer directly may contact the lower glass layer or the upper glass layer.

In some embodiments, the room-temperature adhesive material may include a pressure sensitive adhesive (PSA) or an optically clear adhesive (OCA).

In some embodiments, the thickness of the adhesive layer may range from about 100 μm to about 500 μm.

In some embodiments, the thickness of the adhesive layer may range from about 150 μm to about 300 μm.

In some embodiments, the room-temperature adhesive material may include an ultraviolet (UV) curing material.

In some embodiments, the thickness of the adhesive layer may be less than or equal to 150 μm and greater than or equal to a value that is 10 μm greater than warpage of the upper glass layer.

In some embodiments, the thickness of the adhesive layer may be less than or equal to 100 μm and greater than or equal to a value that is 10 μm greater than warpage of the upper glass layer.

According to another embodiment, a glass-glass laminate includes a first glass layer, a first adhesive layer on the first glass layer, a second glass layer on the first adhesive layer, a second adhesive layer on the second glass layer, a third glass layer on the second adhesive layer, a first decoration layer between the first glass layer and the first adhesive layer or between the second glass layer and the first adhesive layer, and a second decoration layer between the second glass layer and the second adhesive layer or between the third glass layer and the second adhesive layer, wherein the first adhesive layer and the second adhesive layer each comprise a room-temperature adhesive material.

According to another embodiment, a method of manufacturing a glass-glass laminate includes forming a decoration layer on an upper glass layer or a lower glass layer, attaching an adhesive layer to the lower glass layer, the adhesive layer comprising a room-temperature adhesive material, and attaching an upper glass layer to the adhesive layer.

In some embodiments, the method may be performed at room temperature.

In some embodiments, the forming of the decoration layer may include printing the decoration layer on the upper glass layer or the lower glass layer.

In some embodiments, the room-temperature adhesive material may include a pressure sensitive adhesive (PSA) or an optically clear adhesive (OCA).

According to another embodiment, a method of manufacturing a glass-glass laminate includes forming a decoration layer on an upper glass layer or a lower glass layer, applying an ultraviolet (UV) curing adhesive material in a liquid state to the lower glass layer, attaching the upper glass layer to the UV curing adhesive material, and forming an adhesive layer by curing the UV curing adhesive material.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view of a glass-glass laminate according to embodiments;

FIG. 2 is a cross-sectional view of a glass-glass laminate according to embodiments;

FIG. 3 is a cross-sectional view of a glass-glass laminate according to embodiments;

FIG. 4 is a cross-sectional view of a glass-glass laminate according to embodiments;

FIG. 5 is a cross-sectional view of a glass-glass laminate according to embodiments;

FIG. 6 is a cross-sectional view of a glass-glass laminate according to embodiments;

FIG. 7 is a cross-sectional view of a glass-glass laminate according to embodiments;

FIG. 8 is a flowchart of a method of manufacturing a glass-glass laminate according to embodiments;

FIGS. 9A to 9C are cross-sectional views for illustrating a method of manufacturing a glass-glass laminate according to embodiments;

FIG. 10 is a flowchart of a method of manufacturing a glass-glass laminate according to embodiments;

FIGS. 11A to 11C are cross-sectional views for illustrating a method of manufacturing a glass-glass laminate according to embodiments;

FIG. 12 is a flowchart of a method of cutting a glass-glass laminate according to embodiments; and

FIGS. 13A to 13C are cross-sectional views for illustrating a method of cutting a glass-glass laminate according to embodiments.

### DETAILED DESCRIPTION

Hereinafter, embodiments of the disclosure will be described in detail with reference to the accompanying drawings. However, as the embodiments of the disclosure may be modified in various forms, the scope of the present disclosure should not be construed as being limited by the following embodiments. Embodiments of the disclosure should be interpreted as being provided to explain the present disclosure in detail to those skilled in the art. Throughout the drawings, like reference numerals may denote like constituent elements. Furthermore, various components and areas in the drawings are schematically illustrated. Accordingly, the present disclosure is not limited by the relative size or distance drawn in the accompanying drawings.

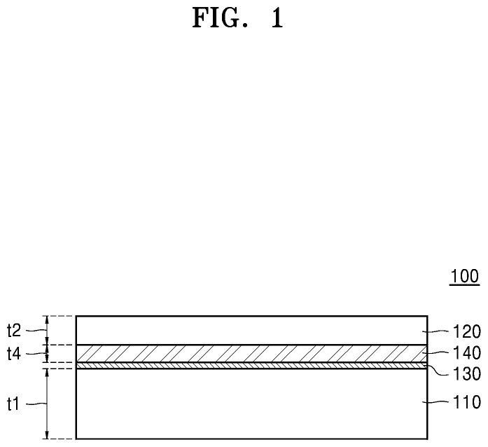

FIG. 1 is a cross-sectional view of a glass-glass laminate 100 according to embodiments.

Referring to FIG. 1, the glass-glass laminate 100 may include a lower glass layer 110, an adhesive layer 140 on the lower glass layer 110, an upper glass layer 120 on the adhesive layer 140, and a decoration layer 130 between the lower glass layer 110 and the adhesive layer 140. In other words, the glass-glass laminate 100 may include the lower glass layer 110, the decoration layer 130, the adhesive layer 140, and the upper glass layer 120, which are sequentially stacked.

The lower glass layer 110 may include arbitrary glass including soda lime glass, aluminosilicate glass, borosilicate glass, aluminoborosilicate glass, alkali-aluminosilicate glass, alkali-borosilicate glass, or alkali-alum inoborosilicate glass.

In some embodiments, a thickness t1 of the lower glass layer 110 may be about 0.1 mm to about 17 mm. When the thickness t1 of the lower glass layer 110 is less than about 0.1 mm, the lower glass layer 110 is too thin to provide sufficient mechanical support to the glass-glass laminate 100 so that manufacture of the glass-glass laminate 100 may be difficult. When the thickness t1 of the lower glass layer 110 exceeds 17 mm, the lower glass layer 110 is so thick that cutting and processing of the glass-glass laminate 100 may be difficult. The thickness t1 of the lower glass layer 110 may be about 0.4 mm to about 12 mm.

The decoration layer 130 may be printed on the lower glass layer 110. Accordingly, the decoration layer 130 may be in direct contact with the lower glass layer 110. In other words, no additional adhesive layer may be needed between the decoration layer 130 and the lower glass layer 110. The decoration layer 130 may be formed on the lower glass layer 110 to improve an aesthetic sense of the glass-glass laminate 100. The decoration layer 130 may show various colors, textures, and/or images. In some embodiments, the decoration layer 130 may be a layer formed by inkjet printing that is relatively vulnerable to heat.

The upper glass layer 120 may include arbitrary glass including soda lime glass, aluminosilicate glass, borosilicate glass, aluminoborosilicate glass, alkali-aluminosilicate glass, alkali-borosilicate glass, or alkali-aluminoborosilicate glass. In some embodiments, the upper glass layer 120 may be Gorilla® glass or Willow® glass that is available from Corning Incorporated.

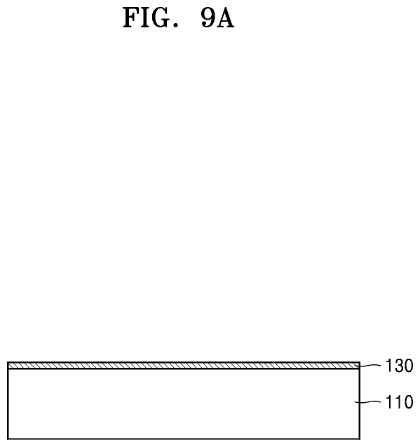

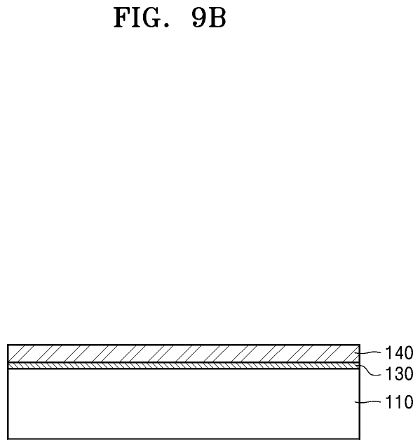

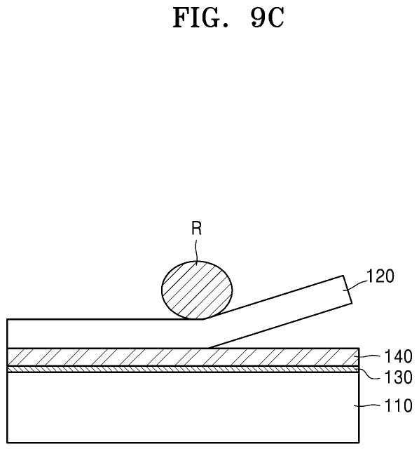

In some embodiments, a thickness t2 of the upper glass layer 120 may be about 0.1 mm to about 1.5 mm. When the thickness t2 of the upper glass layer 120 is less than about 0.1 mm, the upper glass layer 120 is too thin to provide sufficient mechanical support to the glass-glass laminate 100 so that manufacture of the glass-glass laminate 100 may be difficult. When the thickness t2 of the upper glass layer 120 exceeds about 1.5 mm, the upper glass layer 120 is so thick that it may be difficult to bend the upper glass layer 120 when the upper glass layer 120 is attached to the lower glass layer 110 (see operation in FIG. 9C). Accordingly, the manufacture of the glass-glass laminate 100 may be difficult.

The adhesive layer 140 may attach the upper glass layer 120 to the lower glass layer 110. The adhesive layer 140 may include a room-temperature adhesive material. In a conventional glass-glass laminate, PVB is used to attach sheets of glass. To attach sheets of glass by using PVB, heating is necessary, and due to the heating, the decoration layer 130 may be deformed and heat induced stress may be generated in the lower glass layer 110 and the upper glass layer 120. Furthermore, it may be difficult to cut a thermally cured PVB film so that cutting a glass-glass laminate may be difficult.

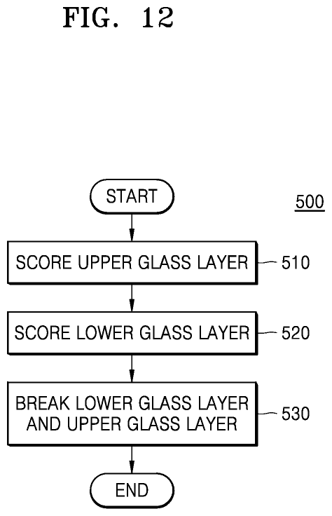

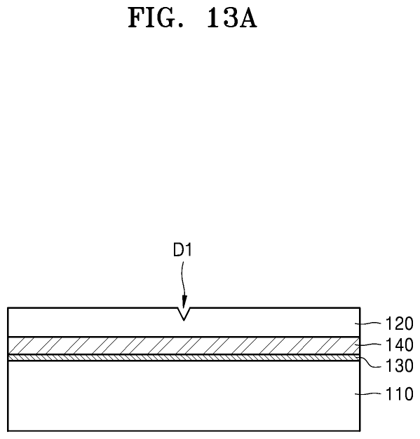

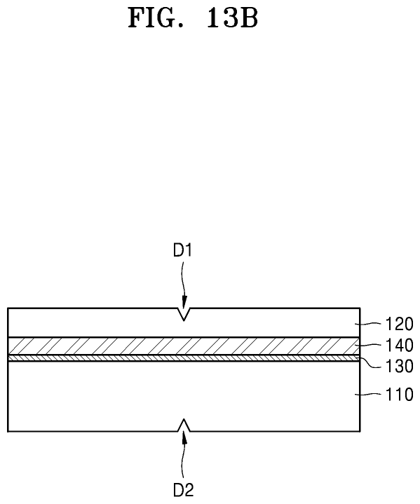

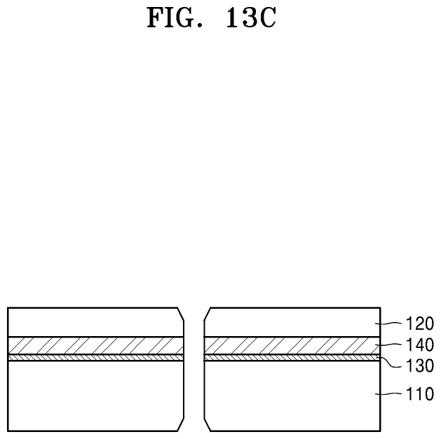

In the glass-glass laminate 100 of the disclosure, a room-temperature adhesive material may be used as the adhesive layer 140 instead of the thermoset PVB film. Accordingly, as a high-temperature process for manufacturing the glass-glass laminate 100 is unnecessary, thermal deformation of the decoration layer 130 and heat induced stress in the lower and upper glass layers 110 and 120 may be prevented. Furthermore, after manufacture, cutting and processing of the glass-glass laminate 100 may be easier. For example, a glass-glass laminate according to an embodiment may be easily cut by a scoring-breaking cutting method described with reference to FIG. 12 and FIGS. 13A to 13C. Accordingly, the glass-glass laminate 100 according to an embodiment may be easily cut and processed at a work site.

The room-temperature adhesive material may mean a certain material capable of attaching the upper and lower glass layers 110 and 120 without heating. The room-temperature adhesive material may include, for example, a pressure sensitive adhesive (PSA), an optically clear adhesive (OCA), or an ultraviolet (UV) curing material.

When the room-temperature adhesive material includes a PSA or an OCA, a thickness t4 of the adhesive layer 140 may be about 100 μm to about 500 μm. When the thickness t4 of the adhesive layer 140 is less than about 100 μm, the adhesive layer 140 is so thin that the lower and upper glass layers 110 and 120 may be broken or air bubbles may be captured when attaching the lower and upper glass layers 110 and 120. When the thickness t4 of the adhesive layer 140 exceeds about 500 μm, the adhesive layer 140 is so thick that it may be difficult to cut and process the glass-glass laminate 100. The thickness t4 of the adhesive layer 140 may be about 150 μm to about 300 μm.

When the room-temperature adhesive material may include a UV curing material, the thickness t4 of the adhesive layer 140 may be less than or equal to about 150 μm. When the thickness t4 of the adhesive layer 140 exceeds about 150 μm, an upper portion of the adhesive layer 140 is overcured so that discoloration and deformation of the adhesive layer 140 may be caused. The thickness t4 of the adhesive layer 140 may be less than or equal to about 100 μm. The UV curing material may include acryl resin, epoxy resin, or acrylic urethane resin.

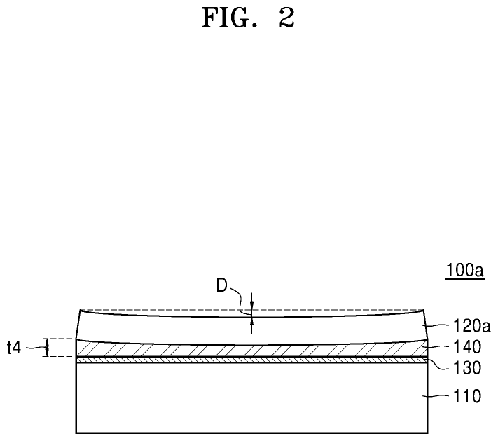

FIG. 2 is across-sectional view of a glass-glass laminate 100a according to embodiments. In the following description, only the differences between the glass-glass laminate 100 of FIG. 1 and the glass-glass laminate 100a of FIG. 2 are described.

Referring to FIG. 2, the glass-glass laminate 100a may include an upper glass layer 120a that is bent. An absolute value of a warpage D of the upper glass layer 120a may be about 0 to about 500 μm. When the absolute value of the warpage D of the upper glass layer 120a exceeds about 500 μm, and the adhesive layer 140 includes a PSA or an OCA, air bubbles may be generated. When the absolute value of the warpage D of the upper glass layer 120a exceeds about 500 μm, and the adhesive layer 140 includes an UV curing material, as the thickness of the adhesive layer 140 that is UV cured increases so that a part of the adhesive layer 140 is overcured, discoloration of the adhesive layer 140 or deformation of the glass-glass laminate 100a occurs. Furthermore, as the adhesive layer 140 is thick and UV curable, cutting and processing of the glass-glass laminate 100a may be difficult.

When the adhesive layer 140 includes a UV curing material, the thickness t4 of the adhesive layer 140 may be greater than or equal to a value that is about 10 μm greater than the warpage D of the upper glass layer 120a. When the thickness t4 of the adhesive layer 140 is less than a value that is about 10 μm greater than the warpage D of the upper glass layer 120a, the thickness t4 of the adhesive layer 140 is so small that a partial area of the upper glass layer 120 may not be attached to the adhesive layer 140, and a change in the thickness of the adhesive layer 140 may be too great.

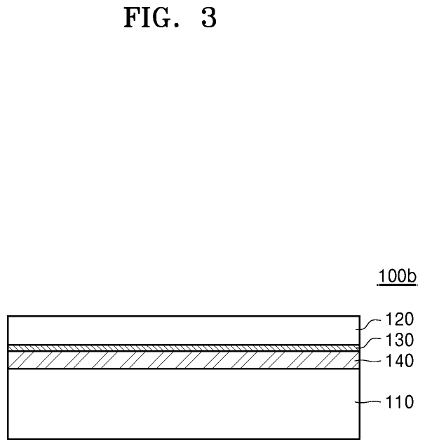

FIG. 3 is a cross-sectional view of a glass-glass laminate 100b according to embodiments. In the following description, only the differences between the glass-glass laminate 100 of FIG. 1 and the glass-glass laminate 100b of FIG. 3 are described.

Referring to FIG. 3, the decoration layer 130 may be located between the adhesive layer 140 and the upper glass layer 120. In other words, the glass-glass laminate 100b may include the lower glass layer 110, the adhesive layer 140, the decoration layer 130, and the upper glass layer 120, which are sequentially stacked. The decoration layer 130 may be a layer printed on the upper glass 120. Accordingly, the decoration layer 130 may be in direct contact with the upper glass layer 120.

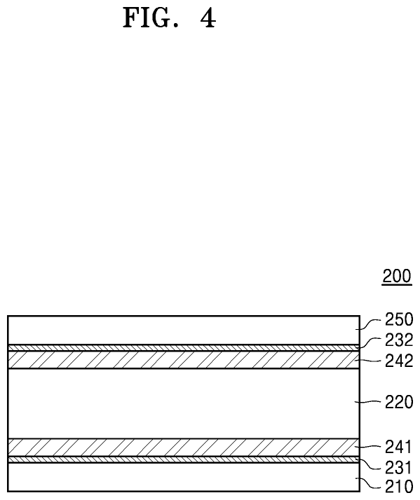

FIG. 4 is a cross-sectional view of a glass-glass laminate 200 according to embodiments.

Referring to FIG. 4, the glass-glass laminate 200 may include a first glass layer 210, a first adhesive layer 241 on the first glass layer 210, a second glass layer 220 on the first adhesive layer 241, a second adhesive layer 242 on the second glass layer 220, a third glass layer 250 on the second adhesive layer 242, a first decoration layer 231 between the first glass layer 210 and the first adhesive layer 241, and a second decoration layer 232 between the second adhesive layer 242 and the third glass layer 250. In other words, the glass-glass laminate 200 may include the first glass layer 210, the first decoration layer 231, the first adhesive layer 241, the second glass layer 220, the second adhesive layer 242, the second decoration layer 232, and the third glass layer 250, which are sequentially stacked.

The first adhesive layer 241 may attach the first glass layer 210 to the second glass layer 220. The second adhesive layer 242 may attach the third glass layer 250 to the second glass layer 220. The first decoration layer 231 may be in direct contact with the first glass layer 210. The second decoration layer 232 may be in direct contact with the third glass layer 250.

As detailed descriptions on the first glass layer 210 and the third glass layer 250 are the same as the detailed description on the upper glass layer 120 of FIG. 1, descriptions thereof are omitted. As detailed descriptions on the first decoration layer 231 and the second decoration layer 232 are the same as the detailed description on the decoration layer 130 of FIG. 1, descriptions thereof are omitted. As detailed descriptions on the first adhesive layer 241 and the second adhesive layer 242 are the same as the detailed description on the adhesive layer 140 of FIG. 1, descriptions thereof are omitted. As the detailed description on the second glass layer 220 is the same as the detailed description on the lower glass layer 110 of FIG. 1, a description thereof is omitted.

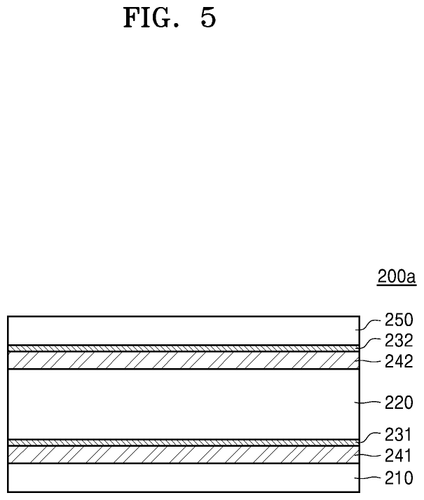

FIG. 5 is a cross-sectional view of a glass-glass laminate 200a according to embodiments. In the following description, only the differences between the glass-glass laminate 200 of FIG. 4 and the glass-glass laminate 200a of FIG. 5 are described.

Referring to FIG. 5, the first decoration layer 231 may be located between the first adhesive layer 241 and the second glass layer 220. In other words, the glass-glass laminate 200a may include the first glass layer 210, the first adhesive layer 241, the first decoration layer 231, the second glass layer 220, the second adhesive layer 242, the second decoration layer 232, and the third glass layer 250, which are sequentially stacked. The first decoration layer 231 may be in direct contact with the second glass layer 220.

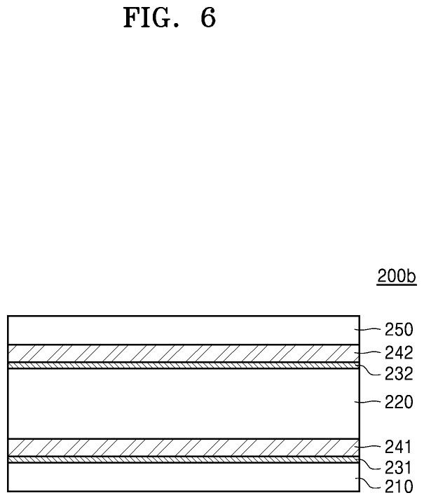

FIG. 6 is a cross-sectional view of a glass-glass laminate 200b according to embodiments. In the following description, only the differences between the glass-glass laminate 200 of FIG. 4 and the glass-glass laminate 200b of FIG. 6 are described.

Referring to FIG. 6, the second decoration layer 232 may be located between the second adhesive layer 242 and the second glass layer 220. In other words, the glass-glass laminate 200b may include the first glass layer 210, the first decoration layer 231, the first adhesive layer 241, the second glass layer 220, the second decoration layer 232, the second adhesive layer 242, and the third glass layer 250, which are sequentially stacked. The second decoration layer 232 may be in direct contact with the second glass layer 220.

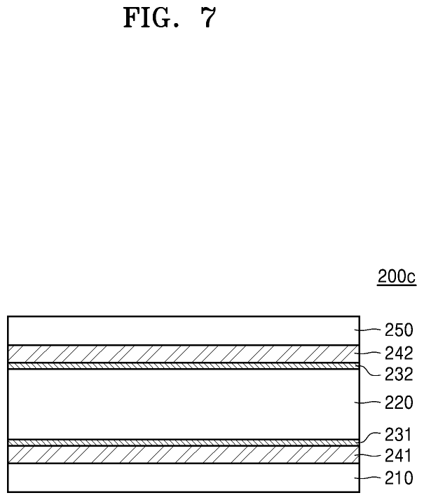

FIG. 7 is a cross-sectional view of a glass-glass laminate 200c according to embodiments. In the following description, only the differences between the glass-glass laminate 200 of FIG. 4 and the glass-glass laminate 200c of FIG. 7 are described.

Referring to FIG. 7, the first decoration layer 231 may be located between the first adhesive layer 241 and the second glass layer 220 and the second decoration layer 232 may be located between the second adhesive layer 242 and the second glass layer 220. In other words, the glass-glass laminate 200c may include the first glass layer 210, the first adhesive layer 241, the first decoration layer 231, the second glass layer 220, the second decoration layer 232, the second adhesive layer 242, and the third glass layer 250, which are sequentially stacked. The first decoration layer 231 may be in direct contact with the second glass layer 220, and the second decoration layer 232 may be in direct contact with the second glass layer 220.

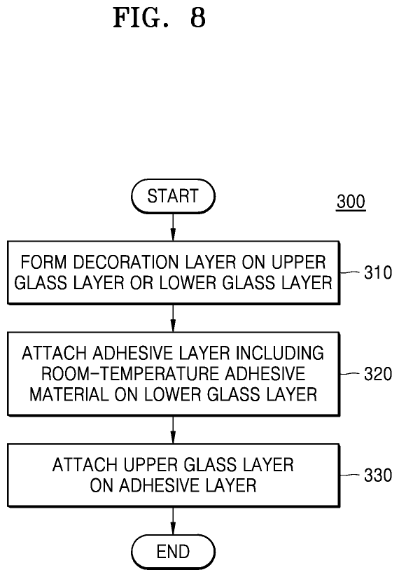

FIG. 8 is a flowchart for illustrating a method 300 of manufacturing a glass-glass laminate according to embodiments. FIGS. 9A to 9C are cross-sectional views of the method 300 of manufacturing a glass-glass laminate according to embodiments.

Referring to FIGS. 8 and 9A, the decoration layer 130 may be formed on the lower glass layer 110 (310). In some embodiments, the decoration layer 130 may be printed on the lower glass layer 110. For example, the decoration layer 130 may be printed on the lower glass layer 110 by using inkjet printing. A printing method is not limited to inkjet printing, but includes laser printing, silk screen printing, or slip decals.

Referring to FIGS. 8 and 9B, the adhesive layer 140 including a room-temperature adhesive material may be attached on the lower glass layer 110 so that the decoration layer 130 is in contact with the adhesive layer 140 (320). The room-temperature adhesive material may include an OCA or a PSA. The OCA or the PSA may be in the form of a film or a tape.

Referring to FIGS. 8 and 9C, the upper glass layer 120 may be attached on the adhesive layer 140 (330). In some embodiments, a roller R may be used to attach the upper glass layer 120 on the adhesive layer 140. When the upper glass layer 120 is attached, the upper glass layer 120 may be bent.

The glass-glass laminate 100 of FIG. 1 may be manufactured according to the method 300 described with reference to FIG. 8 and FIGS. 9A to 9C. The method 300 may be performed at room temperature. Accordingly, the deformation of the decoration layer 130 due to heat and stress induced by the heat in the lower and upper glass layers 110 and 120 may be prevented.

Referring to FIG. 8 and FIG. 3, the decoration layer 130 may be formed on the upper glass layer 120 (310). The adhesive layer 140 including the room-temperature adhesive material may be attached on the lower glass layer 110 (320). Next, the upper glass layer 120 may be attached on the adhesive layer 140 so that the decoration layer 130 is in contact with the adhesive layer 140 (330). The glass-glass laminate 100b of FIG. 3 may be manufactured according to the method 300 described with reference to FIGS. 8 and 3.

Referring to FIG. 4, the first decoration layer 231 may be formed, for example, printed, on the first glass layer 210, and the second decoration layer 232 may be formed, for example, printed, on the third glass layer 250. Next, the first adhesive layer 241 including a room-temperature adhesive material may be attached on the second glass layer 220 so that the first decoration layer 231 is in contact with the first adhesive layer 241. Next, the first glass layer 210 may be attached on the first adhesive layer 241. Furthermore, the second adhesive layer 242 including a room-temperature adhesive material may be attached on the second glass layer 220. Next, the third glass layer 250 may be attached on the second adhesive layer 242 so that the second decoration layer 232 is in contact with the second adhesive layer 242. Accordingly, the glass-glass laminate 200 of FIG. 4 may be manufactured.

Referring to FIG. 5, the first decoration layer 231 may be formed, for example, printed, on the second glass layer 220, and the second decoration layer 232 may be formed, for example, printed, on the third glass layer 250. Next, the first adhesive layer 241 including a room-temperature adhesive material may be attached on the second glass layer 220 so that the first decoration layer 231 is in contact with the first adhesive layer 241. Next, the first glass layer 210 may be attached on the first adhesive layer 241. Furthermore, the second adhesive layer 242 including a room-temperature adhesive material may be attached on the second glass layer 220. Next, the third glass layer 250 may be attached on the second adhesive layer 242 so that the second decoration layer 232 is in contact with the second adhesive layer 242. Accordingly, the glass-glass laminate 200a of FIG. 5 may be manufactured.

Referring to FIG. 6, the first decoration layer 231 may be formed, for example, printed, on the first glass layer 210, and the second decoration layer 232 may be formed, for example, printed, on the second glass layer 220. Next, the first adhesive layer 241 including a room-temperature adhesive material may be attached on the second glass layer 220. Next, the first glass layer 210 may be attached on the first adhesive layer 241 so that the first decoration layer 231 is in contact with the first adhesive layer 241. Furthermore, the second adhesive layer 242 including a room-temperature adhesive material may be attached on the second glass layer 220 so that the second decoration layer 232 is in contact with the second adhesive layer 242. Next, the third glass layer 250 may be attached on the second adhesive layer 242. Accordingly, the glass-glass laminate 200b of FIG. 6 may be manufactured.

Referring to FIG. 7, the first decoration layer 231 and the second decoration layer 232 may be respectively formed, for example, printed, on two surfaces facing each other of the second glass layer 220. Next, the first adhesive layer 241 including a room-temperature adhesive material may be attached on the second glass layer 220 so that the first decoration layer 231 is in contact with the first adhesive layer 241. Next, the first glass layer 210 may be attached on the first adhesive layer 241. Furthermore, the second adhesive layer 242 including a room-temperature adhesive material may be attached on the second glass layer 220 so that the second decoration layer 232 is in contact with the second adhesive layer 242. Next, the third glass layer 250 may be attached on the second adhesive layer 242. Accordingly, the glass-glass laminate 200c of FIG. 7 may be manufactured.

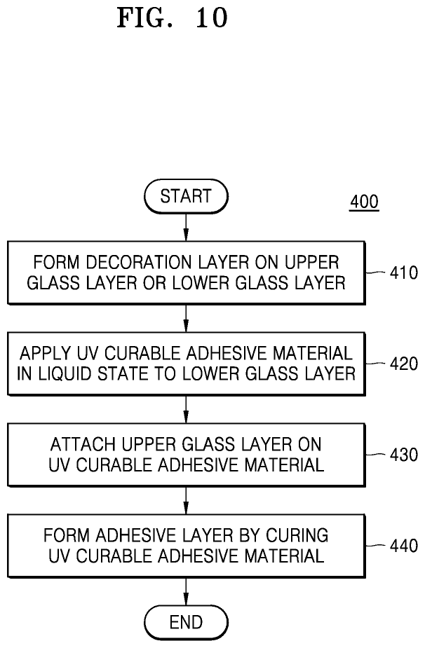

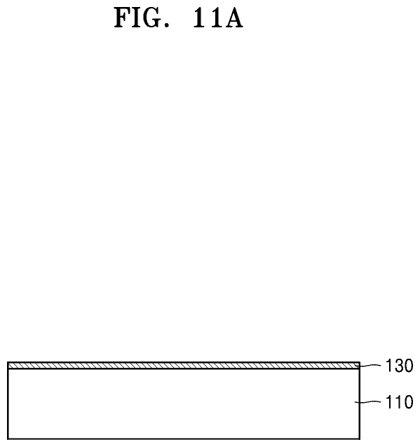

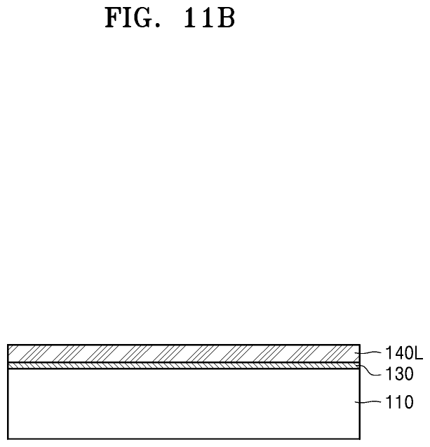

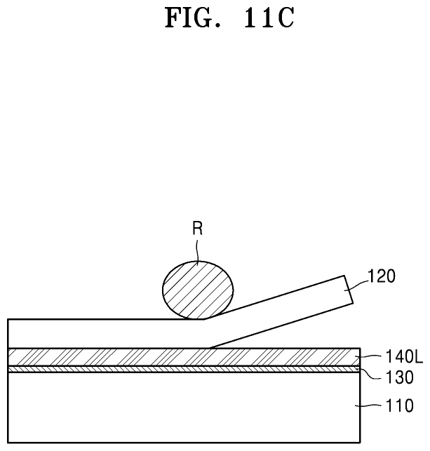

FIG. 10 is a flowchart of a method 400 of manufacturing a glass-glass laminate according to embodiments. FIGS. 11A to 110 are cross-sectional views for illustrating the method 400 of manufacturing a glass-glass laminate according to embodiments.

Referring to FIGS. 10 and 11A, the decoration layer 130 may be formed on the lower glass layer 110 (410). In some embodiments, the decoration layer 130 may be printed on the lower glass layer 110. For example, the decoration layer 130 may be printed on the lower glass layer 110 by using inkjet printing.

Referring to FIGS. 10 and 11B, a UV curing adhesive material 140L in a liquid state may be applied to the lower glass layer 110, for example, on the decoration layer 130 (420).

Referring to FIGS. 10 and 110, the upper glass layer 120 may be attached on the UV curing adhesive material 140L (430). In some embodiments, the roller R may be used to attach the upper glass layer 120 on the UV curing adhesive material 140L. When the upper glass layer 120 is attached, the upper glass layer 120 may be bent.

Referring to FIGS. 1 and 110, the adhesive layer 140 may be formed by curing the UV curing adhesive material 140L. For example, UV light may be irradiated onto the UV curing adhesive material 140L for about 1 second to about 10 minutes, for example, about 5 seconds to about 5 minutes, or about 10 seconds to about 1 minute.

The glass-glass laminate 100 of FIG. 1 may be manufactured according to the method 400 described with reference to FIGS. 1, 10, and 11A to 11C. The method 400 may be performed at room temperature. Accordingly, the deformation of the decoration layer 130 due to heat and stress induced by the heat in the lower and upper glass layers 110 and 120 may be prevented.

Referring to FIGS. 3 and 10, the decoration layer 130 may be formed on the upper glass layer 120 (410). Next, a UV curing adhesive material in a liquid state may be applied to on the lower glass layer 110 (420). The upper glass layer 120 may be attached on the UV curing adhesive material so that the decoration layer 130 is in contact with the UV curing adhesive material (430). Next, the adhesive layer 140 may be formed by curing the UV curing adhesive material. The glass-glass laminate 100b of FIG. 3 may be manufactured according to the method 400 described with reference to FIGS. 10 and 3.

Referring to FIG. 4, the first decoration layer 231 may be formed, for example, printed, on the first glass layer 210, and the second decoration layer 232 may be formed, for example, printed, on the third glass layer 250. Next, a UV curing adhesive material in a liquid state may be applied to the second glass layer 220. The first glass layer 210 may be attached on the UV curing adhesive material so that the first decoration layer 231 is in contact with the UV curing adhesive material. Next, the first adhesive layer 241 may be formed by curing the UV curing adhesive material. Furthermore, the UV curing adhesive material in a liquid state may be applied to the second glass layer 220. The third glass layer 250 may be attached on the UV curing adhesive material so that the second decoration layer 232 is in contact with the UV curing adhesive material. Next, the second adhesive layer 242 may be formed by curing the UV curing adhesive material. Accordingly, the glass-glass laminate 200 of FIG. 4 may be manufactured.

Referring to FIG. 5, the first decoration layer 231 may be formed, for example, printed, on the second glass layer 220, and the second decoration layer 232 may be formed, for example, printed, on the third glass layer 250. Next, a UV curing adhesive material in a liquid state may be applied to the second glass layer 220, for example, the first decoration layer 231. The first glass layer 210 may be attached on the UV curing adhesive material. Next, the first adhesive layer 241 may be formed by curing the UV curing adhesive material. Furthermore, the UV curing adhesive material in a liquid state may be applied to the second glass layer 220. The third glass layer 250 may be attached on the UV curing adhesive material so that the second decoration layer 232 is in contact with the UV curing adhesive material. Next, the second adhesive layer 242 may be formed by curing the UV curing adhesive material. Accordingly, the glass-glass laminate 200a of FIG. 5 may be manufactured.

Referring to FIG. 6, the first decoration layer 231 may be formed, for example, printed, on the first glass layer 210, and the second decoration layer 232 may be formed, for example, printed, on the second glass layer 220. Next, a UV curing adhesive material in a liquid state may be applied to the second glass layer 220. The first glass layer 210 may be attached on the UV curing adhesive material so that the first decoration layer 231 is in contact with the UV curing adhesive material. Next, the first adhesive layer 241 may be formed by curing the UV curing adhesive material. Furthermore, the UV curing adhesive material in a liquid state may be applied to the second glass layer 220, for example, the second decoration layer 232. The third glass layer 250 may be attached on the UV curing adhesive material. Next, the second adhesive layer 242 may be formed by curing the UV curing adhesive material. Accordingly, the glass-glass laminate 200b of FIG. 6 may be manufactured.

Referring to FIG. 7, the first decoration layer 231 and the second decoration layer 232 may be respectively formed, for example, printed, on the two surfaces facing each other of the second glass layer 220. Next, a UV curing adhesive material in a liquid state may be applied to the second glass layer 220, for example, the first decoration layer 231. The first glass layer 210 may be attached on the UV curing adhesive material. Next, the first adhesive layer 241 may be formed by curing the UV curing adhesive material. Furthermore, the UV curing adhesive material in a liquid state may be applied to the second glass layer 220, for example, the second decoration layer 232. The third glass layer 250 may be attached on the UV curing adhesive material. Next, the second adhesive layer 242 may be formed by curing the UV curing adhesive material. Accordingly, the glass-glass laminate 200c of FIG. 7 may be manufactured.

FIG. 12 is a flowchart of a method 500 of cutting a glass-glass laminate according to embodiments. FIGS. 13A to 13C are cross-sectional views for illustrating the method 500 of cutting a glass-glass laminate according to embodiments.

Referring to FIGS. 12 and 13A, the upper glass layer 120 is scored (510). In other words, a first defect D1 is formed on the upper glass layer 120.

Referring to FIGS. 12 and 13B, the lower glass layer 110 is scored (520), that is, a second defect D2 is formed on the lower glass layer 110. The second defect D2 may be formed to be aligned with the first defect D1.

Referring to FIGS. 12 and 13C, the upper glass layer 120 and the lower glass layer 110 may be broken (530). The upper glass layer 120 and the lower glass layer 110 may be guided to be cut from the first defect D1 and the second defect D2.

The glass-glass laminates 100, 100a, and 100b of FIGS. 1 to 3 may be cut by using the method 500 described with reference to FIG. 12 and FIGS. 13A to 13C. Accordingly, glass-glass laminates may be easily cut by using a scoring-breaking method at work sites.

Referring to FIGS. 4 to 7, the third glass layer 250 may be scored. Furthermore, the first glass layer 210 may be scored. Next, the first glass layer 210, the second glass layer 220, and the third glass layer 250 may be broken. Accordingly, the glass-glass laminates 200, 200a, 200b, and 200c of FIGS. 4 to 7 may be cut.

It should be understood that the embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A glass-glass laminate comprising:
a lower glass layer;
an adhesive layer on the lower glass layer;
an upper glass layer on the adhesive layer; and
a decoration layer between the lower glass layer and the adhesive layer or between the upper glass layer and the adhesive layer,
wherein the adhesive layer comprises a room-temperature adhesive material.

2. The glass-glass laminate of claim 1, wherein a thickness of the upper glass layer ranges from 0.1 mm to 1.5 mm.

3. The glass-glass laminate of claim 1, wherein an absolute value of warpage of the upper glass layer ranges from 0 μm to 500 μm.

4. The glass-glass laminate of claim 1, wherein a thickness of the lower glass layer ranges from about 0.1 mm to about 17 mm.

5. The glass-glass laminate of claim 4, wherein the thickness of the lower glass layer ranges from 0.4 mm to 12 mm.

6. The glass-glass laminate of claim 1, wherein the decoration layer directly contacts the lower glass layer or the upper glass layer.

7. The glass-glass laminate of claim 1, wherein the room-temperature adhesive material comprises a pressure sensitive adhesive (PSA) or an optically clear adhesive (OCA).

8. The glass-glass laminate of claim 7, wherein a thickness of the adhesive layer ranges from 100 μm to 500 μm.

9. The glass-glass laminate of claim 8, wherein a thickness of the adhesive layer ranges from 150 μm to 300 μm.

10. The glass-glass laminate of claim 1, wherein the room-temperature adhesive material comprises an ultraviolet (UV) curing material.

11. The glass-glass laminate of claim 10, wherein a thickness of the adhesive layer is less than or equal to 150 μm and is greater than or equal to a value that is 10 μm greater than warpage of the upper glass layer.

12. The glass-glass laminate of claim 11, wherein a thickness of the adhesive layer is less than or equal to 100 μm and is greater than or equal to a value that is 10 μm greater than warpage of the upper glass layer.

13. A glass-glass laminate comprising:
a first glass layer;
a first adhesive layer on the first glass layer;
a second glass layer on the first adhesive layer;
a second adhesive layer on the second glass layer;
a third glass layer on the second adhesive layer;
a first decoration layer between the first glass layer and the first adhesive layer or between the second glass layer and the first adhesive layer; and
a second decoration layer between the second glass layer and the second adhesive layer or between the third glass layer and the second adhesive layer,
wherein the first adhesive layer and the second adhesive layer comprise a room-temperature adhesive material.

14. A method of manufacturing a glass-glass laminate, the method comprising:
forming a decoration layer on an upper glass layer or a lower glass layer;
attaching an adhesive layer to the lower glass layer, the adhesive layer comprising a room-temperature adhesive material; and
attaching an upper glass layer to the adhesive layer.

15. The method of claim 14, the method being performed at room temperature.

16. The method of claim 14 or 15, wherein the forming of the decoration layer comprises printing the decoration layer on the upper glass layer or the lower glass layer.

17. The method of claim 14, wherein the room-temperature adhesive material comprises a pressure sensitive adhesive (PSA) or an optically clear adhesive (OCA).

18. A method of manufacturing a glass-glass laminate, the method comprising:
forming a decoration layer on an upper glass layer or a lower glass layer;
applying an ultraviolet (UV) curing adhesive material in a liquid state to the lower glass layer;
attaching the upper glass layer to the UV curing adhesive material; and
forming an adhesive layer by curing the UV curing adhesive material.
